(19) United States
(12) Patent Application Publication
(10) Pub. No.: US 2009/0241815 A1
(43) Pub. Date: Oct. 1, 2009

(54) Heat Protection Body for a Protection System for an Interior Wall of a Furnace

(75) Inventors: Stephan Mulch, Butzbach (DE); Joachim Meurer, Viersen (DE)

Correspondence Address: PROSKAUER ROSE LLP, ONE INTERNATIONAL PLACE, BOSTON, MA, 02110, US

(73) Assignee: SAINT-GOBAIN INDUSTRIEKERAMIK DÜSSELDORF GMBH, DÜSSELDORF (DE)

(21) Appl. No.: 11/721,930

(22) PCT Filed: Dec. 24, 2005
(86) PCT No.: PCT/EP2005/014029

§ 371 Date: Oct. 12, 2007

(30) Foreign Application Priority Data
Dec. 30, 2004 (DE) 10 2004 063 813.6

(51) Int. Cl. F22B 37/08; F23M 5/00; B23P 17/00

(52) U.S. Cl. 110/323; 110/336; 29/897.3

(57) ABSTRACT

A heat protection body for a protection system for an internal wall of a furnace includes a front, a rear, and edge sides that connect the front to the rear. The heat protection body is characterized in that at its rear it comprises at least one retaining element which is made from the same material as is the heat protection body. The heat protection body can be used within a protection system for a boiler tube wall as well as in a method for installing such a protection system.

### CROSS-REFERENCE TO RELATED APPLICATIONS

This application is a National Phase Application of International Application No. PCT/EP2005/014029, filed Dec. 24, 2005, which claims benefit of priority to German Application No. DE 10 2004 063813.6-23, filed Dec. 30, 2004, which is owned by the assignee of the instant application. The disclosure of each of the above applications is incorporated herein by reference in its entirety.

### BACKGROUND

The invention relates to a heat protection body for a protection system for an interior wall of a furnace. Furthermore, the invention relates to a protection system for a boiler tube wall, as well as to a method for producing such a protection system.

The interior walls of industrial furnaces, for example in garbage incineration plants, have to be protected by special protection systems from the very hot and corrosive combustion gases. In a furnace known from practical application the interior wall of the furnace is a boiler tube wall. For protection against combustion gases the boiler tube wall comprises a layer of a ceramic compound, for example silicon carbide. In order to ensure a safe grip of the ceramic layer on the boiler tube wall, steel studs are welded to the tubes at regular spacing, which steel studs protrude into the ceramic layer, thus establishing a clamping connection between the boiler tube wall and the layer.

The rough surface of the ceramic layer on the side facing the interior of the furnace poses a problem in this wall protection that can be implemented relatively economically. During operation of the furnace, fly-ash is deposited on said rough surface, which fly-ash over time reacts with the ceramic layer, which results in hard encrustations on the surface. Such encrustations have to be removed with a lot of effort. Furthermore, combustion gases enter the porous layer, which after some time results in corrosion of the steel studs that protrude into the layer. This can in turn be prevented in that the metal studs comprise caps that are also made of a ceramic material, for example of silicon carbide. However, this is an elaborate and expensive measure.

In a further wall protection device, also known from practical application, the boiler tube wall is lined with tube protection plates. In this arrangement the tube protection plates are individually held by retaining elements that protrude from the boiler tube wall, which retaining elements engage corresponding recesses or grooves that are formed in the rear of the tube protection plates. The space between the boiler tube wall and the tube protection plates is back-cast with a ceramic-monolithic filling compound, for example with mortar or with silicon carbide.

However, such a protection system is also associated with disadvantages. For example, the retaining elements that support the tube protection plates have to be welded with great precision to the tubes, or to the webs that interconnect the tubes, in order to ensure that the boiler tube wall is covered by means of the tube protection plates with as few gaps as possible. Moreover, the tube protection plates of the type described are relatively heavy because, as a result of the recesses or grooves formed in their rear, said tube protection plates must not be below a minimum thickness. Moreover, the design of such a protection system is associated with considerable installation effort. Finally, the flue gases can also lead to corrosion of the retaining elements, for which reason said retaining elements have to be replaced after a certain time.

### SUMMARY OF THE INVENTION

Based on this state of the art, one embodiment of the invention provides a heat protection body which distinguishes itself by a long service life, is economical to produce, and is easy to be installed on a boiler tube wall. Furthermore, one embodiment of the invention provides an effective protection system for a boiler tube wall as well as an easily implementable method for installing a protection system for a boiler tube wall.

A heat protection body for a protection system for an internal wall of a furnace includes a front, a rear, and edge sides that connect the front to the rear, in that the rear of the heat protection body comprises at least one retaining element which is made from the same or a similar material as is the heat protection body.

The heat protection body according to the invention features a very simple design. Since in the heat protection body according to the invention no rear recess or groove for accommodating a retaining element has to be provided, the heat protection body can be designed so as to be relatively thin-walled and thus light in weight. By means of the at least one retaining element designed on the rear of the heat protection body said heat protection body can be anchored without any problems in a layer that has been applied to the internal wall of the furnace, which wall is to be protected, for example to a boiler tube wall.

According to the invention the heat protection body and the retaining element are made from the same material; they thus comprise identical thermal and/or mechanical characteristics. As a result of this no thermal stress can occur at the transition between the heat protection body and the retaining element as a result of different thermal expansion coefficients. This decisively contributes to a long service life of the heat protection body according to the invention.

According to a first advantageous embodiment of the invention, the entire heat protection body and the retaining element are designed in one piece. The entire heat protection device can thus be manufactured in a single forming step without the need for any further manufacturing steps, for example for attachment of the retaining element on the basic body.

Preferably, the heat protection body and the retaining element are made from a ceramic material, because said ceramic material provides particularly good thermal stability. In this arrangement the use of materials based on silicon carbide and/or aluminum oxide is particularly advantageous.

The retaining element of the heat protection body can assume different forms. Particularly safe anchoring of the retaining element in the layer applied to the internal wall of the furnace to be protected is ensured when the retaining element is designed in the form of a hook or anchor. In the case of a hook-shaped retaining element it preferably protrudes at an angle of approximately 30° or approximately 45° from the rear of the heat protection body.

According to a further advantageous embodiment of the invention, the heat protection body comprises a smooth front. Preferably, the front comprises a surface of little porosity so that said surface is essentially impermeable or repellent to solid materials (in particular dusts), liquids and/or gases. This effectively prevents deposition and/or infiltration of fly-ash during operation of the furnace.

When anchoring the heat protection body according to the invention in a layer applied to the internal wall of the furnace, the heat protection body as such is also slightly pressed into the layer. In this process the layer material is displaced. If several heat protection bodies are anchored in the layer then the displaced material enters the grooves formed between adjacent heat protection bodies. According to a further advantageous embodiment of the invention, the heat protection body comprises a longitudinal groove on the edge sides. This groove can accommodate the displaced layer material. It is particularly advantageous if the groove cross section is in the form of a segment of a circle. The opposing grooves of adjacent heat protection bodies thus form a cylinder volume which the displaced layer material can enter.

A further embodiment of the invention provides for the front and the rear of the heat protection body to be rectangular in design, and for two opposite edge sides to be bevelled in relation to the front and the rear. In the context of the invention, the bevel of the opposite edge sides means that said edge sides are not arranged so as to be at right angles to the front and the rear, but instead that in cross section they form a parallelogram with the front and the rear. A heat protection body of the described geometry, which together with the same type of heat protection bodies covers an internal wall of the furnace, wherein in each case adjacent heat protection bodies comprise bevelled edge sides, can be replaced particularly easily in the case of damage.

A protection system for a boiler tube wall, in accordance with an embodiment of the invention, includes-a ceramic layer applied to the boiler tube wall, and at least one heat protection body, seated on the layer. The ceramic layer is clamped to the boiler tube wall by way of at least one boiler tube wall retaining element protruding from the boiler tube wall, and wherein the heat protection body is anchored in the ceramic layer by way of its at least one retaining element.

The protection system according to the invention provides effective protection, which is economical to implement, to boiler tube walls. Lining the wall with at least one heat protection body largely prevents the ingress of hot corrosive gases into the protection system. Furthermore, the heat protection bodies no longer establish a direct mechanical connection to the boiler tube wall, which is why it is possible to do without expensive precision-welding work. The aforesaid applies to further advantages in particular in relation to the heat protection body.

The ceramic layer can comprise various materials. Ceramic-monolithic materials, e.g. casting-, ramming-, spraying- or spreading compounds based on silicon carbide and/or aluminum oxide have proven to be particularly expedient.

The at least one boiler tube wall retaining element, which protrudes from the boiler tube wall can comprise various geometries. Preferably, anchors, in particular in the form of Y-anchors, boiler tube studs, slotted studs or wave anchors, in particular of metal, are used.

The boiler tube wall retaining element, which is used to clamp the ceramic layer to the boiler tube wall, can be provided on the tubes and on the webs that connect the tubes. Preferably the at least one retaining element is arranged so as to be flush with the retaining element of the at least one heat protection body.

According to a further embodiment of the invention, the protection system comprises several heat protection bodies, wherein the grooves formed between the heat protection bodies are filled with temperature-resistant ceramic fiber material. The fiber material that has been placed into the grooves comprises favorable sealing properties and due to its elasticity can accommodate the thermally-caused expansion of the heat protection body without this leading to material-loading stress.

A method for installing a protection system for a boiler tube wall includes the following method steps:
attaching the boiler tube wall retaining elements to the boiler tube wall;
applying the ceramic layer to the boiler tube wall;
at least partial setting of the ceramic layer; and
pressing the at least one retaining element of the heat protection body into the ceramic layer in a not yet fully set state (e.g. in the paste-like state) of the ceramic layer so that the heat protection body is seated on the ceramic layer.

The method according to the invention is simple and economical to implement because in contrast to methods known from the state of the art there is no need for method steps that require high precision.

First, the boiler tube wall retaining elements are attached to the boiler tube wall. Said retaining elements can be individually installed on the tubes or/and on the webs located between the tubes. Subsequently the ceramic layer is applied to the boiler tube wall. This can take place with the use of various application techniques. Preferably the layer is sprayed on, rammed on, cast on or spread on. After the application has been completed, the setting process of the ceramic layer is initiated. While the layer is still formable, i.e. as long as it has not yet completely set, the at least one retaining element of the heat protection body is pressed into the ceramic layer so that the heat protection body is seated on the ceramic layer. The setting rate of the binder contained in the ceramic layer can be precisely set by adding retarding agents or accelerating agents.

### BRIEF DESCRIPTION OF THE DRAWINGS

Below, the invention is explained in more detail with reference to a drawing which only shows exemplary embodiments of the invention.

The following are shown:

FIG. 1 a perspective view of a heat protection body according to the invention;

FIG. 2 a lateral view of the heat protection body shown in FIG. 1;

FIG. 3 a longitudinal section of detail III from FIG. 2, of the heat protection body of FIG. 2;

FIG. 4 a top view of a protection system for a boiler tube wall according to the invention;

FIG. 5 a cross sectional view of detail V from FIG. 4, of the heat protection body of the protection system of FIG. 4; and

FIG. 6 an alternative embodiment of the protection system of FIG. 4.

### DESCRIPTION

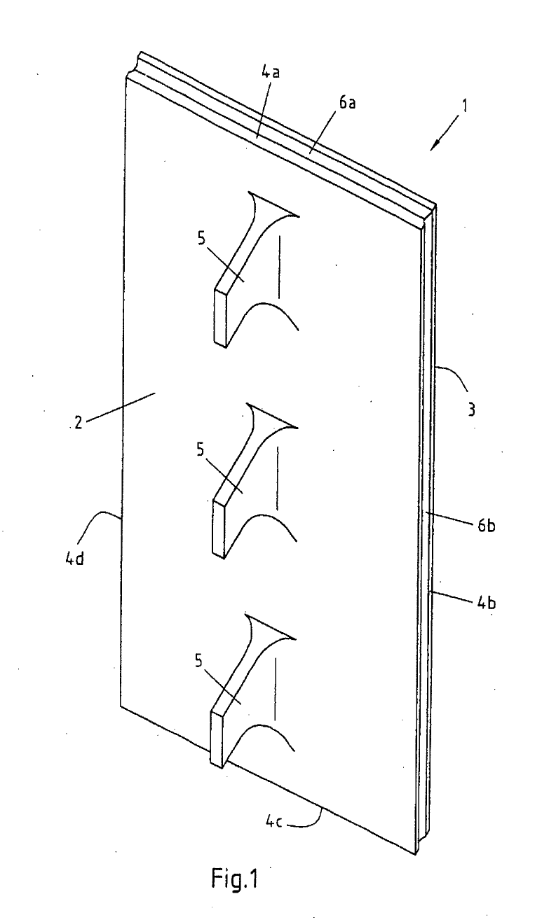

The heat protection body 1, shown in FIG. 1, according to the invention, for a protection system for an internal wall of a furnace, in particular for a boiler tube wall, comprises a front 3, a rear 2, wherein the front and rear 3, 2 are rectangular, and edge sides 4a, 4b, 4c, 4d that connect the front 3 to the rear 2. At its rear the heat protection body 1 comprises at least one—in the present embodiment three—protection system retaining elements 5 that are arranged one underneath the other. In the present embodiment the retaining elements 5 are hook-shaped, wherein in each case they protrude at an angle of approximately 45° from the rear 2 of the heat protection body 1. The retaining elements can also be designed in some other way, for example in an anchor-like manner.

According to the invention the retaining elements 5 are made from the same material as the heat protection body 1. In the present embodiment the heat protection body 1 and the retaining elements 5 uniformly comprise the ceramic material silicon carbide.

The front 3 of the heat protection body 1 comprises a particularly smooth surface so that any deposit of fly-ash during operation can practically be prevented entirely.

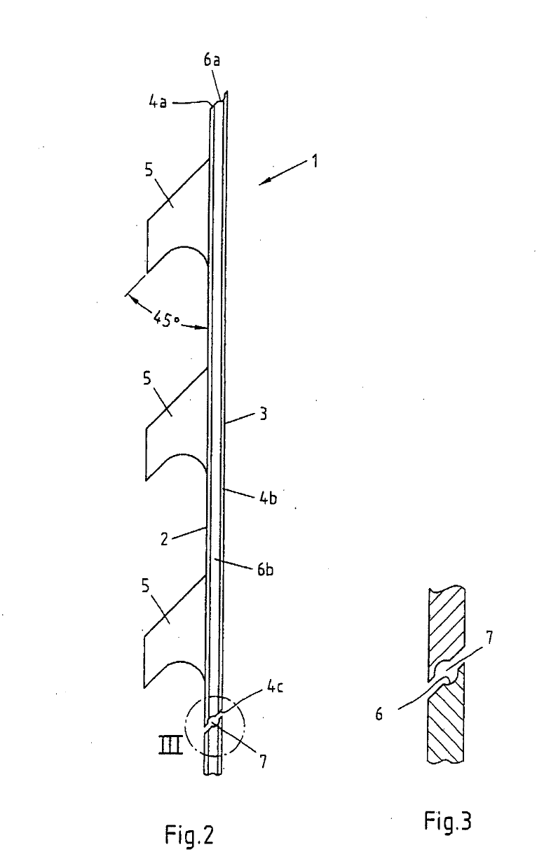

As is shown in particular in FIG. 2, the opposite edge sides 4a, 4c are bevelled in relation to the front 3 and the rear 2, i.e. in contrast to the two other edge sides 4b, 4d, the edge sides 4a, 4c do not form a right angle in relation to the front 3 and the rear 2. In the lateral view of FIG. 2 the heat protection body 1 thus has the shape of a parallelogram. As indicated in FIG. 2 (bottom), a second heat protection body, which is arranged so as to be adjacent to the heat protection body 1, comprises an edge side which is also bevelled and which corresponds to the bevelled edge side 4c. The bevelled opposite edge sides are associated with an advantage in that damaged heat protection bodies, which together with heat protection bodies of the same type cover an internal wall of a furnace, can be replaced particularly easily.

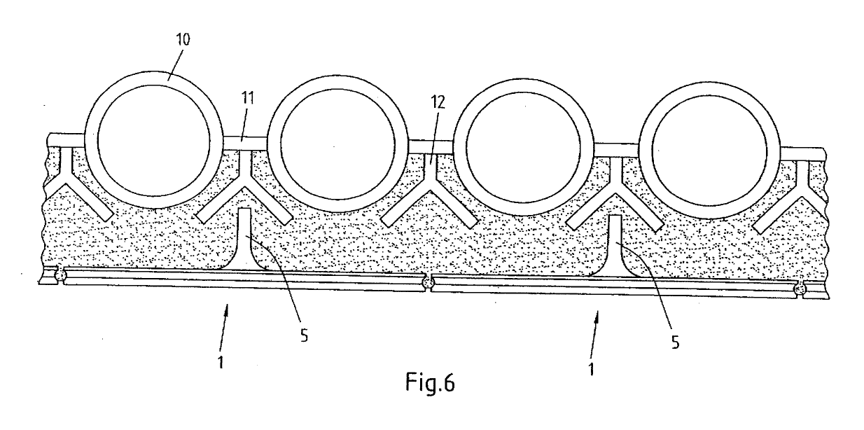

Furthermore, on its four edge sides 4a, 4b, 4c, 4d, the heat protection body 1 in each case comprises a longitudinal groove 6a, 6b, whose cross-section preferably assumes the shape of a segment of a circle. As shown particularly clearly in FIGS. 3 and 5, due to the shape of the groove cross sections and the respective position of the grooves 6a, 6b relative to the parallel edges of the edge sides, in each case facing edge sides of adjacent heat protection bodies 1 enclose a cylinder volume 7.

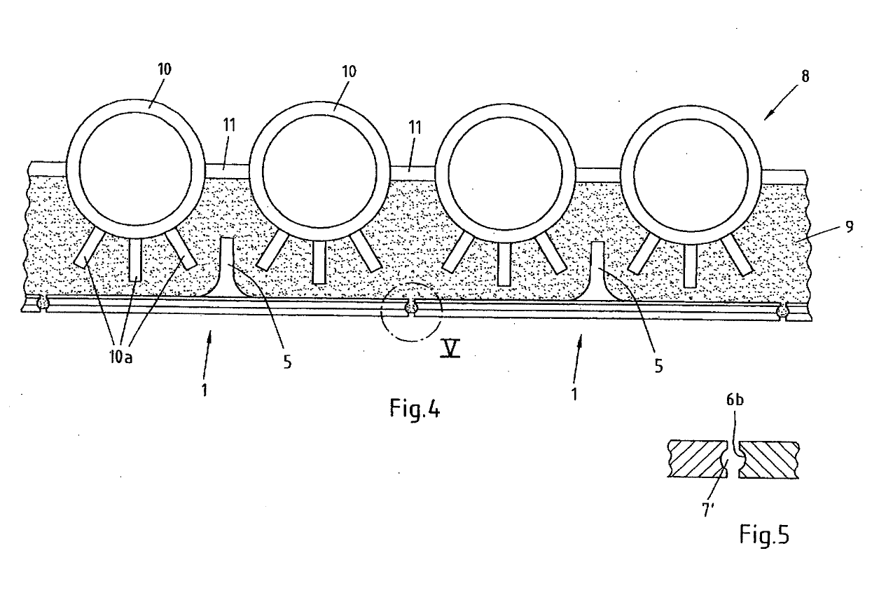

The protection system 8 shown in FIG. 4 and in a modified embodiment in FIG. 6 comprises a boiler tube wall 9, which in turn comprises tubes 10 that extend parallel to each other, and webs 11 that connect the tubes 10. Furthermore, the protection system comprises a ceramic layer 9 which has been applied to one side of the boiler tube wall 8, for example by spraying on, wherein said layer 9 is made of a ceramic-monolithic material, for example mortar or silicon carbide. The ceramic layer 9 is clamped to the boiler tube wall 8 by way of studs 10a that have been welded to the tubes of the boiler tube wall. As an alternative to the studs, it is also possible to provide Y-anchors.

On the side of the ceramic layer 9 that faces away from the boiler tube wall 8 heat protection bodies 1 of the type described above are arranged on top of each other and beside each other in a checkerboard-like manner. In this arrangement the heat protection bodies 1 are anchored to the ceramic layer 9 by way of their retaining elements 5.

During installation of the above-described protection system the heat protection bodies 1 are pressed into the ceramic layer with their retaining elements 5 foremost, and are thus reliably anchored in the layer 9 by way of the retaining elements 5. To this effect the ceramic layer has to be still formable, i.e. not yet fully hardened. In this process the layer material that has been displaced when the heat protection bodies 1 were pressed in enters the joints between each two heat protection bodies 1 that are arranged so as to be adjacent to each other, where said layer material is accommodated by the cylinder volume 7, 7′ enclosed by the grooves 6a, 6b. As an alternative, the layer material can be removed from the joints after installation, and can be replaced by a fiber material that due to its elasticity is able to take up particularly well the thermal expansion of the heat protection bodies 1, which thermal expansion is encountered during operation, without this leading to stress acting on the material.

According to the alternative embodiment, shown in FIG. 6, of the protection system, instead of the boiler tube studs welded to the tubes, boiler tube wall retaining elements 12 in the form of Y-anchors are provided on the webs 11, which boiler tube wall retaining elements 12 assume the function of clamping the ceramic layer 9 to the boiler tube wall. In the present embodiment the retaining elements 12 are designed as Y-anchors and are arranged so as to be partly flush with the hook-shaped retaining elements 5 of the heat protection bodies 1.

1. A heat protection body for a protection system for an internal wall of a furnace, comprising a front, a rear, and edge sides that connect the front to the rears, characterized the rear of the heat protection body comprises at least one retaining element which is made from the same material as is the heat protection body.

2. The heat protection body according to claim 1, in that wherein the heat protection body and the retaining element are designed in one piece.

3. The heat protection body according to claim 1, wherein the heat protection body and the retaining element are made from a ceramic material.

4. The heat protection body according to claim 3, wherein the ceramic material is a material based on at least one of silicon carbide and aluminum oxide.

5. The heat protection body according to claim 1, wherein the retaining element comprises a hook.

6. The heat protection body according to claim 5, wherein the hook protrudes at an angle of about 30° from the rear of the heat protection body.

7. The heat protection body according to claim 5, the hook protrudes at an angle of about 45° from the rear of the heat protection body.

8. The heat protection body according to claim 1, wherein the retaining element comprises an anchor.

9. The heat protection body according to claim 1, wherein the heat protection body comprises a smooth front.

10. The heat protection body according to claim 1, wherein the heat protection body comprises a longitudinal groove on each edge side.

11. The heat protection body according to claim 10, wherein the groove cross section is in the form of a segment of a circle.

12. The heat protection body according to claim 1, wherein the front and the rear of the heat protection body are rectangular in design, and two opposite edge sides are bevelled in relation to the front and the rear.

13. A protection system for a boiler tube wall, comprising a ceramic layer applied to the boiler tube wall, and at least one heat protection body, seated on the layer, according to claim 1, wherein the ceramic layer is clamped to the boiler tube wall by way of at least one boiler tube wall retaining element protruding from the boiler tube wall, and wherein the heat protection body is anchored in the ceramic layer (9) by way of its at least one retaining element.

14. The protection system according to claim 13, wherein the ceramic layer comprises a casting-, ramming-, spraying- or spreading compound based on at least one of silicon carbide and aluminum oxide.

15. The protection system according to claim 13, wherein the at least one boiler tube wall retaining element which protrudes from the boiler tube wall comprises an anchor.

16. The protection system according to claim 13, wherein the at least one boiler tube wall retaining element protrudes from a tube of the boiler tube wall.

17. The protection system according to wherein the at least one boiler tube wall retaining element protrudes from a web that extends between the tubes.

18. The protection system according to claim 13, wherein the at least one boiler tube wall retaining element is arranged so as to be flush with the at least one retaining element of the heat protection body.

19. The protection system according to claim 13, wherein the protection system comprises several heat protection bodies, wherein the grooves formed between the heat protection bodies are filled with at least one of a fiber material and a displaced layer material.

20. A method for installing a protection system for a boiler tube wall according to claim 13 comprises:
attaching the at least one boiler tube wall retaining element to the boiler tube wall;
applying the ceramic layer to the boiler tube wall;
at least partial setting of the ceramic layer; and
pressing the at least one retaining element of the heat protection body into the ceramic layer in a not yet fully set state of the ceramic layer so that the heat protection body is seated on the ceramic layer.

21. The method according to claim 20, wherein the ceramic layer (9) is cast on, spread on, rammed on or sprayed on the boiler tube wall (8).

22. The method according to claim 20, wherein the setting time of the ceramic layer is delayed by adding retarding agents.

23. The method according to, claim 20, wherein the setting time of the ceramic layer is shortened by adding accelerating agents.
